(19) United States
(12) Patent Application Publication
(10) Pub. No.: US 2010/0036934 A1
(43) Pub. Date: Feb. 11, 2010

(54) Network Based Community and Contest System and Method for Same

(76) Inventor: Anthony K. Bruster, Texarkana, TX (US)

Correspondence Address: SLATER & MATSIL, L.L.P., 17950 PRESTON RD, SUITE 1000, DALLAS, TX, 75252-5793, US

(21) Appl. No.: 12/187,983

(22) Filed: Aug. 7, 2008

(51) Int. Cl. G06F 15/16; G06F 17/30

(52) U.S. Cl. 709/219; 707/104.1; 707/E17.009

(57) ABSTRACT

A computer network such as the World Wide Web, private intranet, or the like provides for creating a community of users. Periodically one or more topics are presented on a network site. Users can upload content, such as video files, audio files, pictures, text files, and the like relating to a topic to share with other users. User can also indicate whether they have personally experienced a particular topic and/or whether they desire to experience a particular topic. In some embodiments, a companion program, such as a television show, radio show, podcast, or the like also provides users the ability to review content posted by other users.

### TECHNICAL FIELD

The present invention relates generally to systems for human interactions via computers. In particular, the present invention relates to a system and a method for enhancing a computer user's interactions with another user in a community through a computer networking system

### BACKGROUND

Everyone possesses varying sorts of relationships with others in the world. These relationships span a spectrum of levels from, for example, very close (spouse, family); close (good friends); professional (business acquaintances); social acquaintance; enemy; etc. Daily interactions through personal lives and professional lives cultivate these relationships in their differing roles. However, there is not always a definite distinction between personal and professional relationships. Many times, relationships cross over between the two worlds. For example, a colleague at work may also be a neighbor with whom one carpools, watch sports, etc.

The current state of social networks on the Internet is limited in the distinctive fashion where professional relationships and personal relationships are separated. The current state of social networks on the Internet (particularly, the World Wide Web) are limited in that they typically focus singularly on the idea of “favorites”—favorite music type, favorite music artist, favorite place in the world, favorite song, favorite food, and even favorite color. These types of commonalities between users of these sites are general, dissipating the actual intended impact of users developing a relationship deeper than a distant user in a distant place who is virtually amorphous in nature. These current social networks typically focus on a superficial level of helping in relationship development

Currently, social networks aside from those ascribing to employing “favorites,” or dating services, do not gamer enough personal insight into a user's interests to establish a complete profile. Aside from name, age, location, occupation, and favorites, typical social network fail to delve into the actual personal experiences of users as a means to form a common bond between users. These current networks are dissatisfying because even for the number of users on the Internet, the chances of meeting another individual with common interests or experiences are slight. Networks focusing on “favorites” of users are also inadequate because individuals are interested in more than just “favorites.”

Therefore, what is needed is a method and a system that allows individuals to replicate the process of developing personal relationships through social networks, using a computer system, database, and network through users sharing personal interests and experiences.

### SUMMARY OF THE INVENTION

In one aspect, the present invention provides for a method of creating a community of users on a network. The method includes presenting a topic on a first user-accessible network site and receiving from a user an indication that the user has experienced the topic. The method further includes receiving from the user content relating to the topic and posting on a second user accessible network site the content.

In another aspect, the present invention provides for a computer system. The computer system includes a computer server providing graphical user interface pages responsive to requests from a user. A first graphical user interface page provided by the computer server has a topic and provides for user-posted content relating to the topic, and a user-input element wherein a user can indicate having experienced the topic and wherein a user can indicate a desire to experience the topic. A second graphical user interface page provided by the computer server and relating to a specific user provides content related to the topic posted by the specific user, and a list of other users who have also posted content related to the topic.

In yet another aspect, the present invention provides for a computer readable medium containing programming instructions. The medium includes instructions to present on a remote computer a first graphical user interface page having a link to user-posted content, a link to a topic, and a first input element for a user to indicate having experienced the topic, and a second input element for a user to indicate a desire to experience the topic.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a preferred embodiment graphical user interface homepage with interactive components;

FIG. 2 illustrates a preferred embodiment graphical user interface topical page;

FIG. 3 illustrates a preferred embodiment graphical user interface specific topical page;

FIGS. 4 & 5 illustrate a preferred embodiment graphical user interface profile page; and

FIG. 6 schematically illustrates a preferred embodiment method whereby a user notifies another user of selected content.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention. Embodiments of the present invention are described herein in the context of a system, method, and apparatus for connecting users in an online computer system based on their relationships within social networks. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

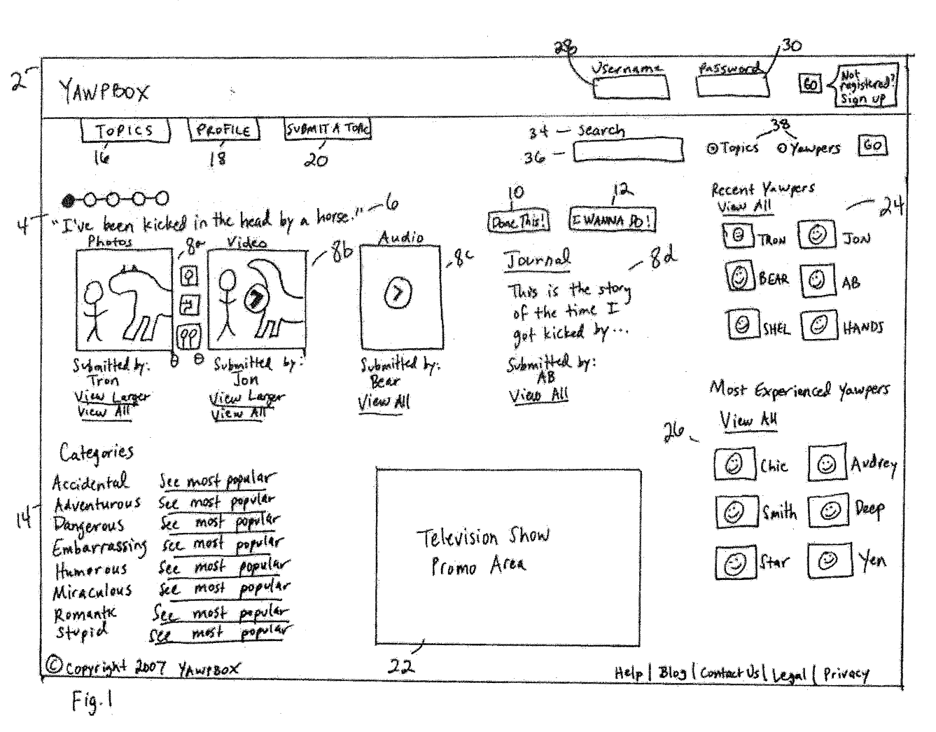

The present invention will be described with reference to a network site (e.g., a World Wide Web site, a private intranet site, or the like) in which a community of users interact with one another through functions, services, and media provided by a site operator. With reference to FIG. 1, an exemplary graphical user interface homepage 2 allows users of a network site to delve into various components offered on homepage 2. Topic box 4 presents various topics 6 chosen by a site operator, presenting one or more topics 6 during a predetermined amount of time. For example, topic box 4 might only show one topic 6 per day or may present five topics 6 for the week in a scrolling method. Topics 6 may describe life experiences with broad applicability with a wide range; for example: “I have been kicked in the head by a horse;” “I have run four marathons;” “I have been stung by a jellyfish,” and the like. The goal of choosing a topic 6 is to encourage users to share their own similar experiences by uploading media on the site in the forms of, but not limited to, text, pictures, audio clips, videos, and any other media supported by the site, and then encouraging interaction among the users. Topics 6 may focus on certain themes, for example, during certain holidays such as July 4^{th}, topics 6 may revolve around this holiday theme such as for example: “I got shot in the head with a Roman Candle firework,” or “I accidentally burned my entire lawn while grilling,” or the like. These themes may range from holidays, current events, pop culture, and other events not listed herein. According to the topics 6 chosen by the site operator, users upload material and media related to topic 6 (as discussed later). Users are encouraged to post their own stories, pictures, audio clips, videos, and any other media supported by the site relating to the topics onto this homepage 2 through the option of the topic submittal tab 20. Viewing users can use the topics page tab 16 to browse through all the stories, pictures, audio clips, videos, and any other media supported by the site relating to the topics on this homepage 2. Additionally, users may propose or submit a topic, as described more fully below.

Homepage 2 further includes media boxes 8, wherein different types of media (including photos, video, audio, text, and other media) relating to the topic 6 are provided. In the embodiment illustrated in FIG. 1, various media have been uploaded relating to topic 6, “I've been kicked in the head by a horse.” Media 8 includes photos 8a, video 8b, and audio 8c. More specifically, media boxes 8 are preferably graphical representations, such as thumbnails, in which are embedded links to the actual media represented by that particular media box 8. For instance, clicking on media box 8a results in relocating or mapping to another page containing all the media of this type, in this example, all the photos under this topic of “I've been kicked in the head by a horse.” The actual photo originally selected from homepage 2 will appear either directly on the page or in the alternative, a pop-up page. Throughout this description, reference to relocating or mapping to another page is intended to broadly cover links, whether to a separate page, a separate Web site, a separate file or group of files, or other location on the network. Likewise, clicking on media box 8b results in relocating to another page containing all the media of this type, in this example, all the videos under this topic of “I've been kicked in the head by a horse.” The actual video originally selected from homepage 2 will appear either directly on the page or in the alternative, a pop-up page and play. Likewise for clicking on media box 8c results in an audio file being played.

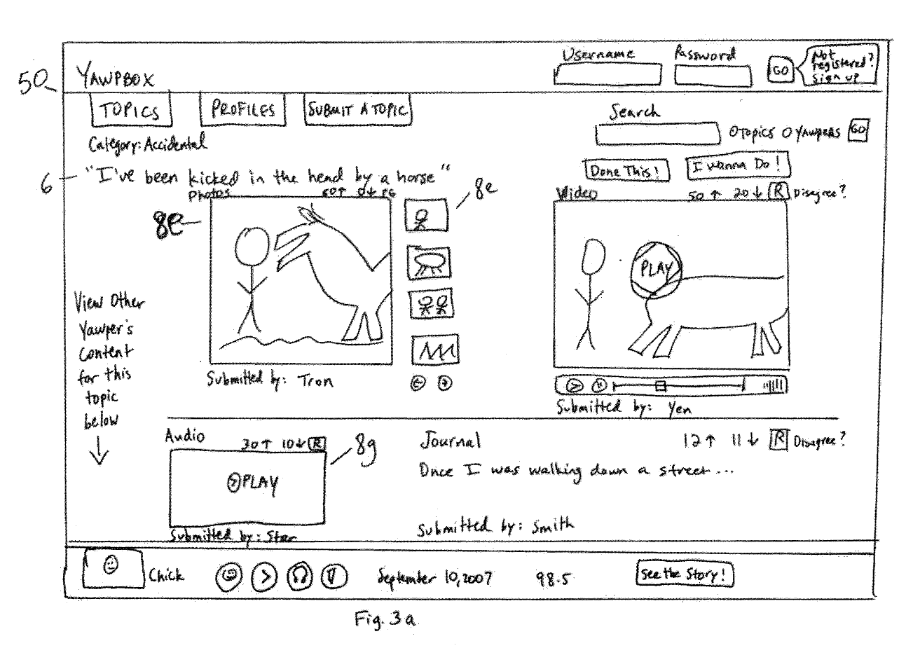

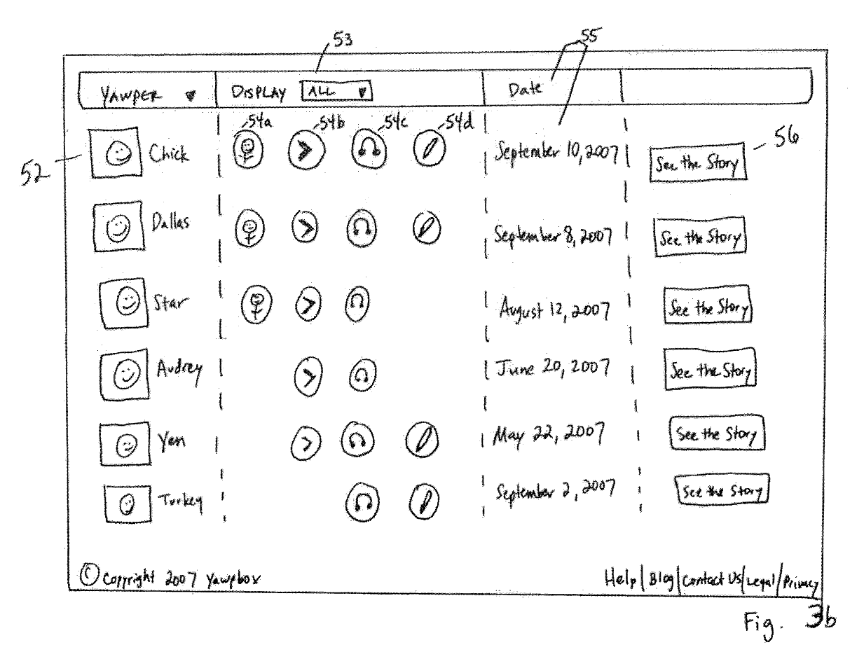

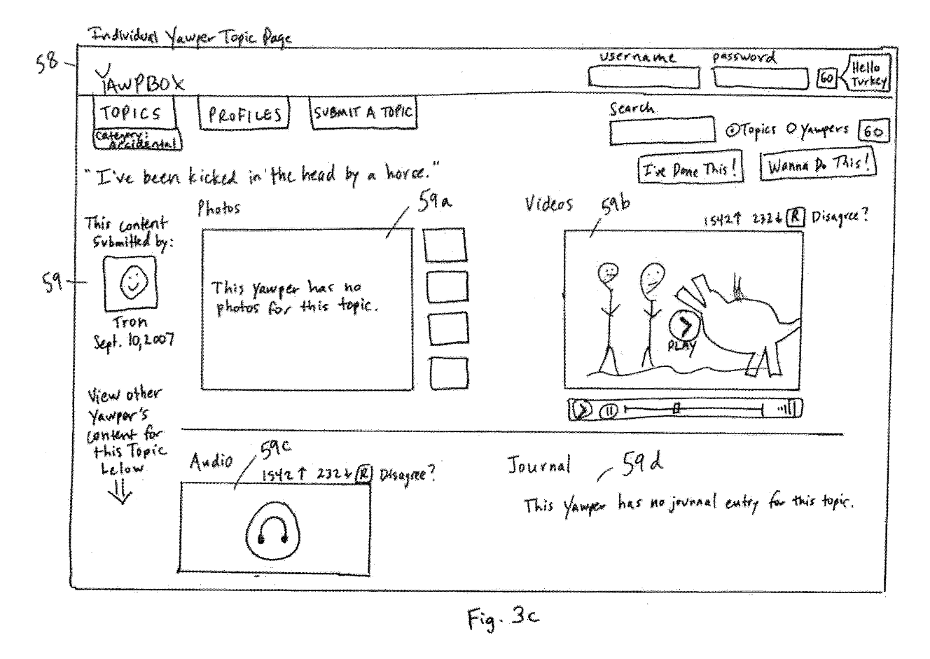

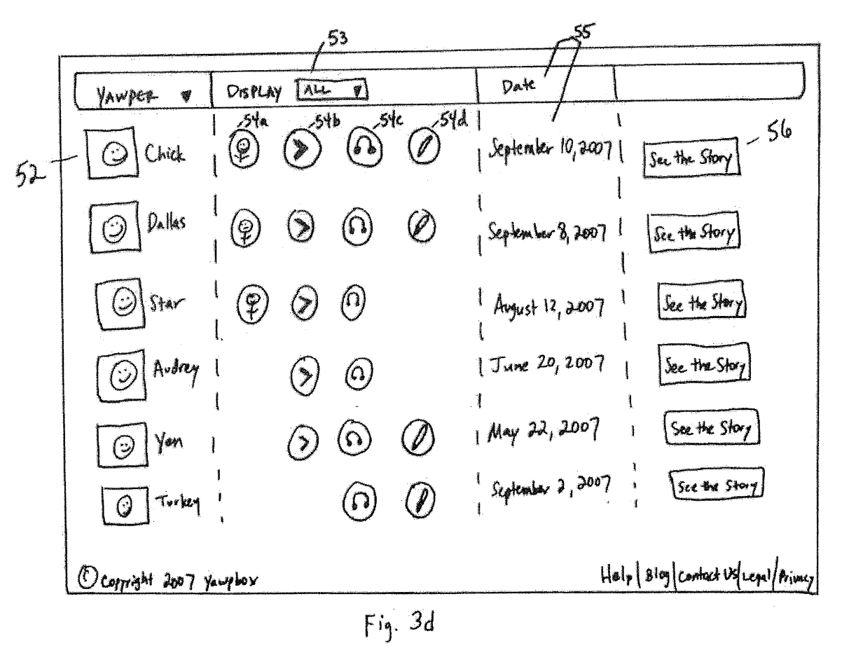

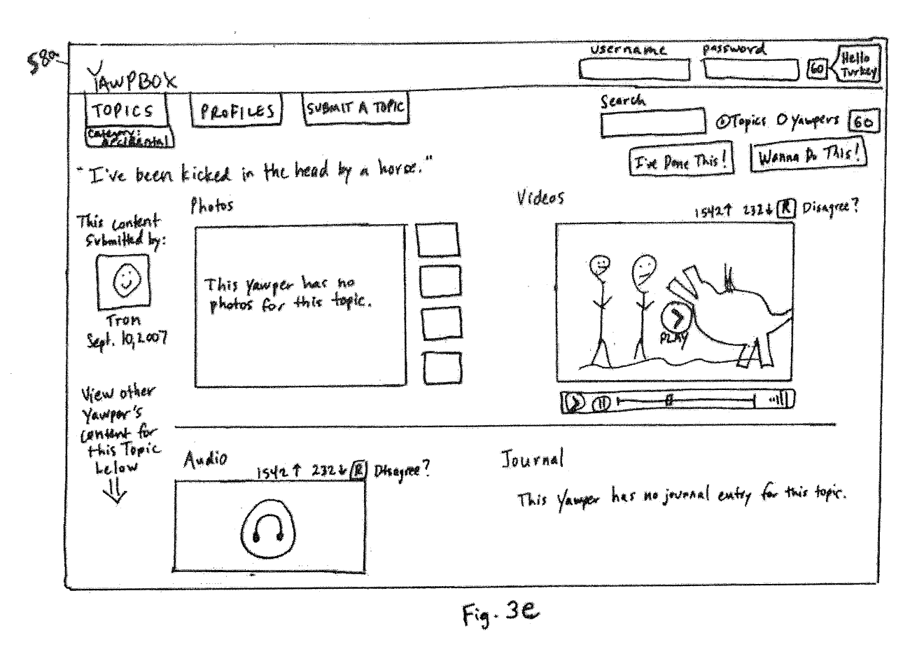

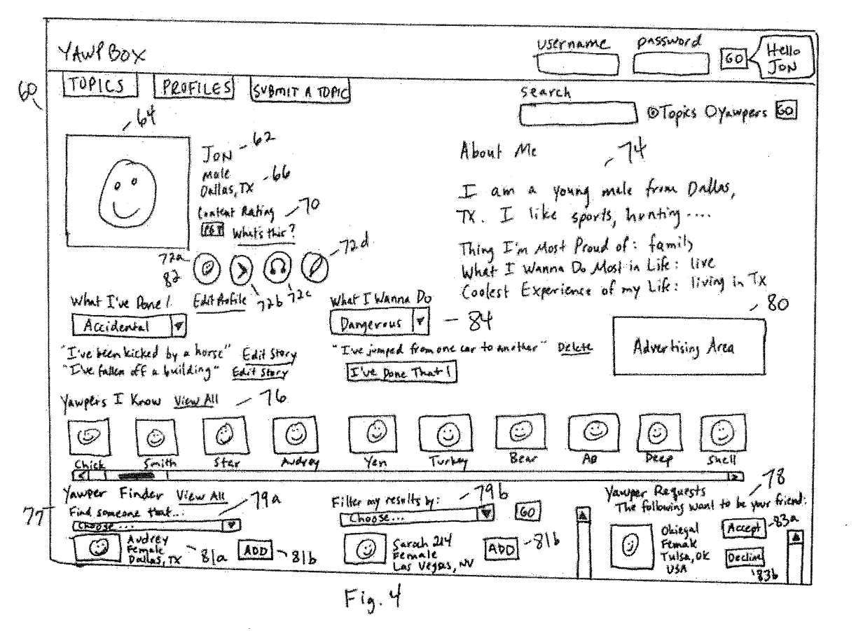

In one embodiment the network site upon which homepage 2 is running provides the specific functionality for displaying the selected media. In other embodiments, the network site may merely deliver sufficient data to the user's computer to allow appropriate “play” (e.g., display a photograph or video clip, play an audio file, or the like) the media. Although media 8 could originate with the site operator or elsewhere, preferably media 8 originates in large part from the community of users interacting with the network site. The manner in which a user uploads or contributes media to the network site will be discussed further below with reference to FIGS. 3e and 4.

Homepage 2 offers a variety of interactive tabs including experience tab 10 and interest tab 12. A user may click experience tab 10 to indicate to the community his/her relation to topic 6. In the illustrated embodiment, experience tab 10 is entitled “I've Done That!” By clicking tab 10, the user indicates to the community that he/she experienced topic 6 currently listed in topic box 4. This information may be linked to a user's personal profile page as will be described in detail below with reference to FIG. 4. Also, clicking this tab 10 links the user to another page or pop-up window, etc., to upload his or her own media relating to this topic, such as FIG. 3e, as will be discussed later. Additionally, a user may click tab 12 to indicate to the community his/her desires to experience topic 6 currently listed in topic box 4. This information may also be linked to a user's personal profile page, as will be further described below.

Another interactive component of the preferred network site includes a system for grouping users by experiences and interests. For example, an exemplary first and second user, referred herein to as User 1 and User 2, respectfully, both click on experience tab 10 regarding topic 6 “I've climbed Mount Everest.” An exemplary third and fourth user, referred to herein as User 3 and User 4, respectfully, both click on interest tab 12 regarding topic 6 “I've climbed Mount Everest.” The network site preferably would group together both User 1 and User 2 and provides to User 1 and User 2 (and other users with similar experiences) a posting site, blog, chat room, message board, or other forms of community communications allowing these users to discuss their common experiences. In some embodiments, User 1 and User 2 would additionally or alternatively be grouped with User 3 and User 4 to promote interaction between users who have experienced a particular topic (“I've Done That!”) and users who desire to have such an experience (“I Wanna Do This!”). By grouping these users together, the network site notifies users of a posting site, blog, chat room, message board, or other forms of community communications allowing users to discuss this topic of interest.

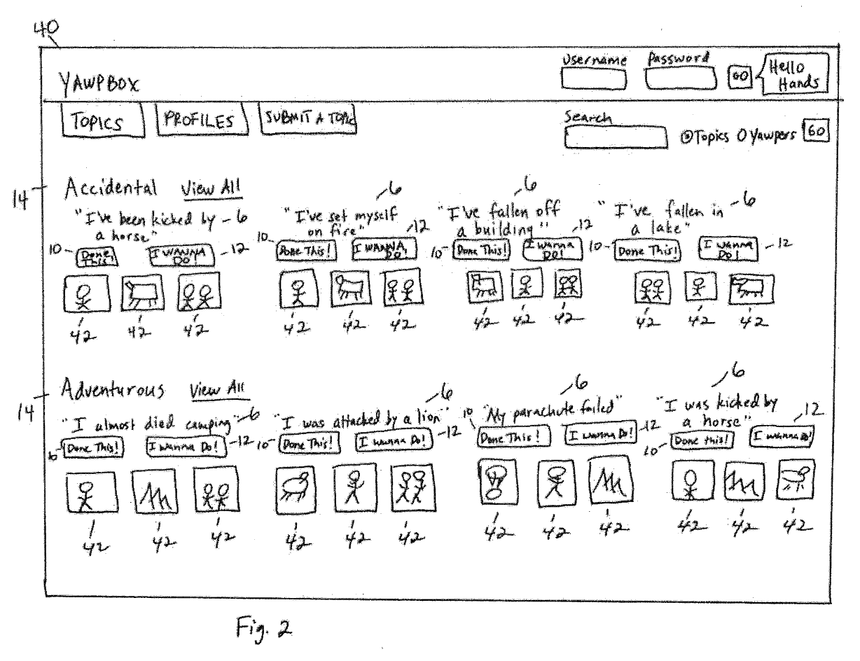

Homepage 2 also includes a list of categories 14, listing various classifications for topics 6 as organized by the site operator (or alternatively, topics 6 could be organized by all or a subset of the user community). Topics can be classified either by the site operator or the users. Categories list 14 provides for an easy browse capability in which a user can click on a particular category 14 and find more topics 6 classified in that particular category 14. Categories 14 may include, but are not limited to: Accidental, Adventurous, Dangerous, Embarrassing, Humorous, Miraculous, Romantic, Stupid, and the like. Another method for seeking out additional topics 6 includes clicking on topics page tab 16 that may provide a link to topics page 40 which is described more fully below with reference to FIG. 2. Also, users may click on “see the most popular topics in this category” and view the most viewed topics under each category in an alternative page that may appear similar to FIG. 2, however, the topics under each category are arranged by the most viewed at the beginning.

Another method provided by homepage 2 for searching topics 6 includes search function, as identified by reference numeral 34. Associated with function 34 is a text box 36 by which a user can enter key words, search strings, and the like. Radio buttons 38 allow a user to direct that search function 34 search for topics (e.g., topics 6) that relate to the search string or key words or that search function 34 searches for other users in the community (referred to as “yawpers” in the illustrated embodiment) whose personal profile (as described more fully below with regard to FIG. 4) relates to the search string or key words input into text box 36. One skilled in the art will recognize that other formats and functions could be employed for entering and directing search inquiries. For instance, search function 34 could include drop-down menus of common search phrases or could allow for audio or graphical inputting of search strings. Additionally, radio buttons 38 could also be embodied as one or more drop-down menus, text boxes, or the like. In additional to, or as an alternative to employing search function 34 to locate users, profile connection tab 18 may provide a link to a profile connection page, which page can be used to search for and identify specific users, as described more fully below with reference to FIG. 4.

Homepage 2 further includes topic submittal tab 20, allowing a user to click on tab 20 and proceed to a topic submittal page. Users may propose topics for consideration as topics 6. The site operator will consider the submitted topics for use as topics 6 and will classify these topics. These submitted topics are preferably not be included in the topics and archive page (FIG. 2) unless selected by the site operator as a topic 6. In order for users to propose topics for consideration, users must submit a text version topic. Users may also upload relevant media and material relating to their submitted topics. These uploads, however, should be submitted via the topic submittal page rather than through alternative means that the network may offer.

Exemplary homepage 2 also includes promotional material 22. Promotional material 22 can be programmed for specific promotional material that may include various types of media uploads supported by the network site. Also, promotional material 22 may provide interactive tabs allowing a user to delve into a promotional page. In a preferred embodiment of the present invention, a promotional page may be featured as an advertisement section for a television and radio (or the like) program linked with this particular site. In a preferred embodiment, the program provides the same or similar media 8 as provided for on homepage 2, but in a broadcast or multicast format—preferably hosted by, e.g., a professional entertainment host, employees of the site operator, or even members of the user community. On the related program, particularly noteworthy uploaded media 8 could broadcast, selected users (so-called “yawpers” in the illustrated embodiment) could be interviewed, additional information regarding the topics 6 could be provided and the like. The promotional page may contain any form and combination of media postings including, but not limited to, text, audio clips, video clips, flash media, streaming video sessions, and other forms of media supported by the site. This promotional page may also have a search function allowing a user to access archived episodes, access scheduling material of upcoming events, episodes, special announcements, and other variations of informational postings.

In order to further enhance and promote interaction amongst the community of users, recent user list 24 is preferably provided on homepage 2. Recent user list 24 preferably provides a graphical presentation of recent users that logged into the network. In one embodiment, each element in the list, such as each graphical representation, has associated with it a link to the represented user's profile page 60 (illustrated in FIG. 4). In the illustrated embodiment, recent user list 24 includes a “View All” link that redirects a user to a recent user list page on which is listed, e.g., a more comprehensive list of recent users, limited profile information for the recent users, recent user search functions, and the like.

Homepage 2 further includes most experienced user list 26. Users are considered “experienced” based upon differing factors determined by the site operator. These determinative factors may include, but are not limited to, the users uploading the most media and material onto the network, users who click experience tab 10 the most frequently, users who visit and login to the network the most often, and other various methods of determining what “experience” may mean. In the embodiment illustrated in FIG. 1, most experienced user list 26 includes a “View All” link that links to a most experienced user page on which is listed, e.g., a more comprehensive list of most experienced users, limited profile information for the most experienced users, most experienced user search functions, and the like.

Homepage 2 preferably requires a user to log into the network to proceed into other restricted areas of the network site. A user may type his/her username (discussed later) into username text box 28 and provide the user's password in password text box 30. Password text box 30 may provide an option tab that allows a user who has forgotten his/her password to retrieve the password via secure predetermined steps. Registration tab 32 allows individuals who are not users of the network the ability to register as a user to the site. Registration includes individuals providing information such as, but not limited to, selecting a username, selecting a password, providing age, sex, location, email address, and other personal information. Registering with the network allows a user to interact within the community social network and may, in a preferred embodiment of the present invention, provide personal profile page 60 as shown in FIG. 4, which will be discussed later.

With reference to FIG. 2, topics page 40 provides a graphical user interface presenting topics 6 from the network's history of topics 6. Topic page 40 may also be considered an archive page that provides a user with the entire bank of the network's topics 6. Topic page 40 may also be broken down by categories 14, and include uploaded media sections 42, similar to uploaded media boxes 8, as shown in FIG. 1. In this example, if a user clicks on any of the media sections 42, the user would be redirected to specific topic page 50 as discussed later with reference to FIG. 3a. To upload media and material to a topic listed on topics page 40, a user need simply to click on “I've Done This!” and this will redirect the user to another page for uploading media, such as individual user topic page 58 as discussed later with reference to FIG. 3c. Also, topics page 40 may include experience tabs 10 and interest tabs 12 for each listed topic 6 listed. As described above, a user may indicate his/her relationship to a particular topic 6 by clicking on either experience tab 10 or interest tab 12. Topics page 40 may also include username text box 28, password text box 30, search function 34, search text box 36, and search command 38 as also provided in homepage 2 with the same functions as in homepage 2. While the various topics 6 are illustrated as organized according to category 14, one skilled in the art will recognize other organization schemes, such as listing the topics 6 alphabetically, sorting the topics 6 by the date on which they were posted, sorting the topics 6 by “theme,” or the like.

With reference to FIG. 3a, specific topic page 50 provides a graphical user interface page that, in a preferred embodiment of the present invention, may be linked with topics 6 from other pages of the network site, including but not limited to, homepage 2 and topics page 40. By selecting a specific topic 6 on homepage 2, a user may proceed to specific topic page 50 that provides more detailed segments for topic 6, including but not limited to, uploaded media boxes 8e-8h. Specific topic page 50 provides a more specific page for a user to explore topic 6 that a user is interested in. Specific topic page 50 may also include username text box 28, password text box 30, search function 34, search text box 36, and search command 38 as also provided in homepage 2 with the same functions as in homepage 2 as shown in FIG. 1.

Clicking topic 6 from homepage 2 will preferably lead to specific topic page 50 with the components as listed above. The lower portion of specific topic page 50 is shown in FIG. 3b. In this illustrated example, users who have submitted material relating to the topic of specific topic page 50 are listed with their user icon 52. Drop-down menu 53 allows the viewing user to choose the specific types of media he/she desires to view, which are available as media 54a-54d. Clicking on any of the media selections 54a-54d, range from photos 54a, video 54b, audio 54c, and text 54d. Clicking on media selections 54a-54d redirects the user to individual user topic page 58 as referenced in FIG. 3c. Date 55 notes the last date of the most recent uploaded media by that user. See story 56 component allows a viewing user to proceed to individual user topic page 58, as shown in FIG. 3c. Also, clicking on user icon 52 redirects a user to the public profile page 90 (as shown in FIG. 5 and discussed further below) of that user associated with user icon 52. As seen in FIG. 3a, each different media box 8, 8e-8h, may have media content submitted by different users: media box 8e is submitted by CorboTron; media box 8f is submitted by YenandYang; media box 8g is submitted by Stars2000; and, media box 8h is submitted by DallasSmiths. After a pre-determined amount of time after the initial posting of topics 6, allowing time for users to upload media for each topic 6, the media content in each media box 8e-8h will reflect the most viewed media. So the media in media boxes 8e-8h may rotate. Users may upload media to this site for postings by clicking “I've Done This!”, being redirected to individual user upload topic page 58a in FIG. 3e, as discussed below, that will allow the user to upload their media and material to the site.

FIG. 3c illustrates individual user topic page 58 and the lower portion of the page is illustrated in FIG. 3d. As discussed above, users may proceed to this individual user topic page 58 e.g., by clicking on see story 57 as illustrated in FIG. 3b. If a viewing user clicked on user icon 52, as illustrated in FIGS. 3b and 3d, or on user icon 59 in FIG. 3c, the viewing user would be redirected to the icon's user's public profile page 90, as discussed further with reference to FIG. 5. Alternatively, users may reach individual user topic page 58 through the media postings on user's public profile page 90 (as discussed later) and also by clicking on the see story tab 56 in FIGS. 3b and 3d.

In this illustrated example, this individual user topic page 58 belongs to CorboTron as indicated by posting user icon 59. The different media uploads are shown in boxes 59a-d, which include photos 59a, video 59b, audio 59c, and text 59d. This is the public viewing page of CorboTron's specific topic, in this example, “I've been kicked in the head by a horse.” Individual user upload topic page 58a, as illustrated in FIG. 3e, is the page in which CorboTron can upload media and update the site for the specific topic, which is then reflected in individual user topic page 58 in FIG. 3c. Individual user upload topic page 58a is limited in access to the user owner, in this example, CorboTron.

For example, CorboTron is viewing homepage 2 (as illustrated in FIG. 1) with topic 6 as “I've been kicked in the head by a horse,” and has experienced this topic 6. CorboTron clicks on the “I've Done This!” tab 10 and is redirected to a page as shown in FIG. 3e with topic 6 (“I've been kicked in the head by a horse”) pre-listed. This page, individual user upload topic page 58a is limited in access to CorboTron as the user owner in this example. Whatever CorboTron enters, uploads, edits on page 58a is reflected in its public version counterpart page in individual user topic page 58 (as illustrated in FIG. 3c). Individual user upload topic page 58a may or may not include the lower portions as illustrated in FIGS. 3b and 3d, as this is merely the uploading site for the user owner.

CorboTron can upload relevant media to the specific topic posted via individual user upload topic page 58a, and when a viewing user (viewing individual user topic page 58) wants to see all of the text selections, or all of the audio selections, the user may click the “view all” link and be redirected to a new page that will show all the media posted at a preview level. The lower half of individual user topic page 58, as shown in FIG. 3d, is similar in setup to that shown in FIG. 3b as discussed above.

With reference to FIG. 4, personal profile page 60 provides a user a master page for interacting with the community social network including managing the user's uploaded media. In accordance with a preferred embodiment of the present invention, personal profile page 60 is accessible to a user after logging into the network via username text box 28 and password text box 30 as shown in FIG. 1. Personal profile page 60 graphically allows a user to edit his/her material on the network site and includes, but is not limited to, username 62, user icon 64 chosen by the user, personal specifics 66 such as for example sex and location, content rating 70, personal media uploads 72, journal section 74, friend list 76, friend invitation list 78, advertisement 80, experiences 82, and interests 84. These elements are further described in the following paragraphs. Personal profile page 60 is limited in access to the user owner. Other users of the network site have access to another user's public profile page 90, but not personal profile page 60. However, material on personal profile page 60 is preferably reflected in unalterable form on public profile page 90.

User icon 64 acts as a visual representation of the user for the network site, commonly referred to as an avatar. User icon 64 can be solely a picture, or can include animation, sounds, or other features. Personal specifics 66 may be provided from information provided by the user during registration, and may include, but is not limited to, age, sex, location, and other personal information.

Content rating component 70 allows a user to select a rating of the content on his/her personal profile page 60. Preferably, the site operator may review the content posted on a user's personal profile page 60 to ensure unacceptable material is not posted on the site. Also, preferably, the site operator may also review content posted to ensure content rating 70 selected by the user is appropriately selected by a standard rating system. Preferably, this rating system consists of an “over and under 18” type of rating wherein users indicate the appropriate rating for their uploaded material, as to whether it is under 18 appropriate or not. Content rating 70 provides a notification to other users of the nature of content on a particular user's public profile page 90 (which will described more fully below with reference to FIG. 5). Preferably, content rating 70 restricts certain users from accessing certain portions and/or pages of the network site. For example, the network site may apply a user's birth date (as provided at the time of registration), to determine if that particular user is old enough to view particular rated content. For example, if User 1 registers with a birth date that catalogs User 1 as a minor (under the age of eighteen), and then User 1 attempts to view public profile page 90 of User 2 that has a content rating 70 of “R,” the network may block access to this particular public profile page 90 and provide an error message describing the purpose of the block.

Icons 72 provide functionality by which a user can upload media relating to the user's various experiences and/or desires. By clicking on icon 72a, a user can see all of the photos that he/she has uploaded. As will be described below with reference to FIG. 5, an analogous icon 91a appears on the user's public profile page 90. Photos uploaded by a user via icon 72a can subsequently be viewed by other users visiting the public profile page 90 associated with private profile page 60. Likewise, by clicking on icon 72b, the user can see all of the video clips that he/she has uploaded, which can also be viewed by clicking on an analogous icon on the associated public profile page 90; the user can see all uploaded audio files by clicking on icon 72c, which has an analogous icon, for listening to the audio files, on associated public page 90, and so on. Similarly, journal section 74 allows a user to read all submitted text that other users can view on public profile page 90, which may allow viewing users to gain a better understanding of this particular user. The user may also employ journal section 74 to, for example, describe himself/herself, highlights about him/her personally, or any other expressive means that he/she may desire to employ. In the alternative, this section 74 could be submitted with text, video, audio, or other forms of media supported by the network.

The concept of “friends” and a “friends list” is well known in the art and is preferable in the unique context of the present invention in order to more fully enhance the sense of community amongst users. “Friends” are other users of the community (or “yawpers” in the lexicon of the illustrated embodiment) which a user has identified as having common interests, common experiences, or the like, and with which the user desires to form a closer relationship. Personal profile page 60 has three sections related to the friends list functionality. List 76 provides a list of friends, as represented by their graphical representations and/or user names, or the like. These are other users of the community that have been identified by the user of profile page 60. A user can interact with friends in various ways by clicking on the appropriate name or icon in the list 76, and hence linking to that friend's public profile page 90 (discussed below with reference to FIG. 5). A user can add another user to his/her friends list 76 by providing an invitation to that other user.

Other users can be identified for inclusion in a friends list in a variety of ways. For instance with reference to FIG. 1, each media box 8 has associated with it the user name of the user who posted the content of media box 8. In the illustrated embodiment, user “CorboTron” submitted a photograph relating to the topic “I've been kicked by a horse;” user “JonAbbott” submitted a video clip relating to that topic, and user “SanchoBear” submitted an audio file relating to that topic. Each of these usernames has a link associated with it. Clicking on the username will direct one to that user's public profile page 90. To add a friend, by clicking on “Add to Yawpers I Know” button 92 (discussed with reference to FIG. 5), an invitation will be sent and displayed on personal profile page 60 of user owner of the public profile page 90. This will place the user clicking on “Add to Yawpers I Know” button 92 onto the user owner's request section 78, as discussed further below.

Potential friends can also be identified and invited to be friends via friend finder 77 of personal profile page 60. Preferably, friend finder 77 (in this example, also known as yawper finder) provides a search capability wherein potential friends can be identified. In the illustrated embodiment, search terms are selected via pull-down menu 79a and the results can be filtered via pull-down menu 79b. Alternatively, search terms could be input using a free text box, by selecting items from a pre-defined list, or other well known alternatives. Illustrative friend finder 77 shows the results of a search wherein matching users are identified by, e.g., an icon, a user name, and/or brief descriptive data 81a. Also associated with each matching user is an Add button 81b. Clicking on Add button 81b associated with a particular associated user causes an invitation to be sent to that associated user. For example, FIG. 4 illustrates a personal profile page 60 for exemplary user JonAbbott. In response to input to the search feature of friend finder 77, the network system has identified various yawpers, or user that meet the search criteria entered by user JonAbbott. These users include Audrey1985, Shelley214, DallasSmiths, and so on. Assuming that user JonAbbott desires to add user Shelley214 as a friend (i.e., as a “Yawpers I Know” on page 60), user JonAbbott clicks on Add button 81b associated with Shelley214. In response, user Shelley214 will receive a request, generated by the network site, to accept user JonAbbott's request to be friends. If user Shelley214 accepts the invitation, user Shelley214 will be added to the friends list (also known as “Yawpers I Know”) 76 on user JonAbbott's personal profile page 60, and user JonAbbott will be added to the friends list (“Yawpers I Know”) 76 of user Shelley214's personal profile page 60. Another avenue for adding another user to one's list of Yawpers I Know is to go that that other user's public profile page 90, as will be discussed below with reference to FIG. 5.

An exemplary graphical interface by which requests to be friends is illustrated as Yawper Requests section 78 of personal profile page 60. In the illustrated embodiment, user OkieGal has made a request to be friends with user JonAbbott (as indicated by the inclusion of user OkieGal's icon and data in the Yawper Requests section 78 of user JonAbbott's personal profile page 60). By clicking on Accept button 83a, JonAbbott can agree to be friends with OkieGal. In that case, the icon and user name for OkieGal will be added to JonAbbott's friends list 76. Likewise, JonAbbott's icon and user name will be added to OkieGal's friends list 76. Alternatively, user JonAbbott can decline the request from OkieGal to be friends by clicking on Decline button 83b. In this case, OkieGal will preferably be informed that the request to be friends with JonAbbott has been denied, preferably by an email or by an appropriate graphical representation on user OkieGal's personal profile page 60.

In accordance with a preferred embodiment of the present invention, personal profile page 60 may include advertisement 80 wherein advertisement 80 may be based on the network's topic 6 or from information gathered from the user's preferences. For example, the network site may select a theme of the month and advertisement 80 may revolve around this theme. In a preferred embodiment of the present invention, topics 6 may focus on the Thanksgiving holiday and advertisement 80 may center around that topic 6 also. Also, in accordance with another preferred embodiment, advertisement 80 may be derived from information gathered from the network's information of a particular user such as location, personal preferences, solicited information, surveys, and information gathered from experiences and interests of the user as expressed on his/her personal profile page 60. For example, User 1 expresses interest in mountain climbing, or has expressed to the community that he has climbed Mount Everest. Advertisement 80, in this situation, may comprise mountain climbing advertisements, recreational equipment companies and the like.

In accordance with a preferred embodiment of the present invention, personal profile page 60 may also include a list of experiences 82 that lists topics the user experienced which the user expresses to the community. Experiences list 82 may be categorized categories such as: Accidental, Adventurous, Dangerous, Embarrassing, Humorous, Miraculous, Romantic, Stupid, and the like.

Personal profile page 60 may also include a list of interests 84 which may comprise a section that lists topics the user is interested in experiencing which the user expresses to the community. Interests list 84 may also categorize these topics into such categories such as: Accidental, Adventurous, Dangerous, Embarrassing, Humorous, Miraculous, Romantic, Stupid, and the like. One skilled in the art will recognize that personal profile page 60 can also provide a means for the user to manage his/her personal relationships with other users by means such as: message posting, chatting, blogging, and other forms of network communication methods.

FIG. 5 shows public profile page 90, a graphical user interface page that, in a preferred embodiment of the present invention, allows other users to browse through a particular user's profile. In public profile page 90 is the public version of personal profile page 60, comprising similar components. Public profile page 90 may be edited through personal profile page 60 by the user owner. As with personal profile page 60, public profile page 90 may include username 62, user icon 64, personal specifics 66, content rating 70 (not shown in FIG. 5), personal media uploads 72, journal section 74, friend list 76, advertisement 80, experiences 82, and interests 84.

Also, in accordance with a preferred embodiment of the present invention, public profile page 90 may also include friend invitation 92 that allows a viewing user to invite the user owner of the viewed public profile page 90, to become an accepted friend on the network site. In other words, assume user JonAbbott is browsing the illustrated public profile page 90 of user NikkiSumrow. By clicking on Add to Yawpers I Know button 92, an invitation will be sent and displayed on personal profile page 60 of user NikkiSumrow, which invitation user NikkiSumrow can accept or decline as described above with reference to FIG. 4.

Also, public profile page 90 may also include populating keys 94 that allow users visiting public profile page 90 to express a connection with experiences 82 and interests 84 selected by, in the illustrated case, user NikkiSumrow. Experiences button 82 and interests button 84 are analogous to experiences button 10 and interests button 12, respectively, described above. In this way, users to public profile page 90 can (i) learn about the experiences and interests of the posting user (i.e. NikkiSumrow in the illustrated embodiment) and (ii) identify to NikkiSumrow the user's own similar experiences and interests. Again, by providing opportunities to users to learn about the experiences and interests of others and to share the users' own experiences and interests, the preferred embodiment network site promotes interaction and community amongst the users.

Preferably populating keys 94 will be linked to a visiting user's own public profile page 90. For example, assume JonAbbott visits user NikkiSumrow's public profile page 90 as illustrated in FIG. 5. User JonAbbott notes that user NikkiSumrow has been kicked in the head by a horse. Coincidentally, user JonAbbott has also been kicked in the head by a horse. By identifying common life experiences, the preferred embodiment system increases the likelihood that users with common interest will find one another. User JonAbbott clicks on populating key 94 associated with the topic “I've been kicked in the head by a horse.” This will populate JonAbbott's profile pages 60 and 90 and also redirect JonAbbott to individual user topic page 58 that will allow JonAbbott to upload media regarding this experience.

For example, if User 2 visits User 1's public profile page 90 and finds under User 1's listed topics of things User 1 has done, accomplished, or experienced the topic listed something that User 2 is also interested in doing, accomplishing, or experiencing, User 2 can click on a link indicating that topic as something User 2 desires to do, accomplish, or experience, to populate User 2's own public profile page 90. For example, when User 2 visits User 1's public profile page 90 and sees that User 1 has jumped from one moving car to another, and User 2 wants to experience this topic, User 2 can click on, for example, a link listed as “I Wanna Do This!” reflecting User 2's desire. This will automatically populate User 2's public personal profile page 90 with the topic and classification of User 2's desire to jump from one moving car to another.

The network site preferably has the ability to garner information from the public profile page 90 when a certain number of profiles have selected an identical or similar experience as a “top experience.” The network site can adapt to post a topic 6 of the day that will draw significant interest from the registered-user base along the same basis as the information from the public personal profile pages 90.

In accordance with a preferred embodiment of the present invention, the public profile page 90 also includes sections where the user of the public profile site 90 has the option to post messages on a message board on another user's public profile page 90. One option of posting may be that User 1 visits User 2's public profile page 90. User 1 is an accepted friend of User 2 on the public profile page 90. When User 1 posts a message on User 2's message board, User 2 may either accept or reject the posting. Another option of posting may be that User 1 visits User 2's public profile page 90 and is only a visitor to User 2's site, not an accepted friend. User 1 posts a message on User 2's message board, User 2 also has the option to accept or reject the posting.

In accordance with a preferred embodiment of the present invention, another area of the public profile page 90 includes the option of chat and notification. The network site provides users with the option to be notified when one of his/her accepted friends is active on the site. This option may also include an option attached to the notification that, manually or automatically engaged, inquires whether the user wishes to contact that friend via a chat function, an email function, a nudge function that alternatively notifies the user's friend that the user is also active on the site at the current moment, or any other network available communication methods. These functions are known in the art and, hence for the sake of brevity, are not illustrated herein.

Another component of this system is the ability for the network site to send out invitations to users with common experiences and interests. The network site recognizes and documents similar interests among users, for example, mountain climbing. In this example, User 1 posts on his/her profile that he/she climbed Mount Everest. User 2 posts on his/her profile that he/she wants to climb Mount Everest. The network searches these keywords such as “Mount,” “Everest,” and “climb.” After determining a match of interest between User 1 and User 2, the network sends out invitations to both users inviting them to correspond with each other. For example, the network would send out an invite to User 1 stating that User 2 wants to climb Mount Everest, would User 1 be interested in connecting to User 2. If so, User 1 would be directed to click a certain link to establish some form of contact with User 2 through, for example, online chat, email, posting boards, and other forms of accepted communication media. User 2 would receive a similar message from the network telling User 2 that User 1 has climbed Mount Everest, inquiring whether User 2 would be interested in connecting to User 1.

Referring back to FIG. 1, another component of homepage 2 includes topic submittal tab 20 allowing users to submit topics to the network for consideration as postings for topics 6. This may require the submitting user to furnish any uploadable data or media to enhance the topic submission. This feature engages users in the development and direction of the network site rather than the network site as a vehicle of personal postings. Users are encouraged to actively participate within the network with the site development, promotional components, and with other users. Preferably, other users can visit a link to the submitted topics and use a vote function to vote on the user-submitted topics. The users can vote for a topic they want to see posted as a topic 6. After tallying the votes, the site owner determines the utilization of the submitted topics, taking into account the user-posted positive feedback.

Another component of a preferred embodiment of this system includes a function allowing users to upload content about their experiences that relate to one of topics 6 presented on the homepage 2. The material sought for this component relates to one of topics 6 that may be considered spin-offs of topics 6, or even topics that exceed the intensity of topics 6. This component allows a user to upload content about his/her experience with topic 6 in an area where the user can post text, pictures, audio files, video files, or other acceptable forms of media about an experience the user has had that is related to, but not quite the same as, topic 6. For example, if the topic 6 is “I have been stung by a jellyfish,” but the user has been stung by an electric eel instead of a jellyfish, the user can post text, pictures, audio files, video files, or other acceptable forms of media about his experience with the electric eel. This area of the network allows users to branch out from the original topics presented by the site into an area that is related to the topic 6, but not quite the same, allowing for virtually limitless stories and other user content to be posted. This component is another piece of the user-involved development of the network, unlike other social networks currently available.

Another advantageous feature of the system is a keyword search function that matches keywords within user experiences and interests. This component may be set according to a certain percentage of similar words in the phrases evaluated. For example, a phrase comparison may consist of:

| | |
|---|---|
| 1. I want to climb Mt. Everest. | (total words = 6) |
| 2. I climbed Mt. Everest. | (total words = 4) |
| 3. I want to watch people climb Mt. Everest. | (total words = 8) |
| 4. I watched people climb Mt. Everest. | (total words = 6) |

The underlined portions of the keyword search phrases are evaluated for the percentage match. As apparent in this example, the sentences all have “climb,” “Mt.,” and “Everest” in common, as highlighted in bold. However, a user who wants to climb Mt. Everest most likely may not want to be connected to another user who watched other people climb Mt. Everest. Therefore, it is necessary for the network server to employ a certain percentage identifier. For example, the percentage of similar words could be set at 55%. Sentences 1 and 2 have 60% of their words in common. As such, the users who submitted those two interest statements would be connected by the network. Sentences 1 and 3 only have 42% of their words in common, so the network would not connect the two users who submitted those interest statements. A percentage range above 50% may be necessary because of situations such as Sentences 2 and 4, where 50% of their words are in common but the topics are different. Sentences 3 and 4 share 71% of their words in common, including “watch” and “people,” as highlighted in italics. The two users who submitted the interest statements would be connected by the network because the interest statement percentage match exceeded 55%, in this example. While an illustrative search function has been provided, those skilled in the art will recognize that a multitude of search and classification functions ranging from simple word matching to complex fuzzy logic algorithms are available and are within the scope of the present invention.

In accordance with a preferred embodiment of the present invention, another component of the system may consist of a rating system wherein users may receive information based on their user-submitted content. For example, if topic 6 describes a scary experience, the ranking may be a “Scary Scale.” If topic 6 is humorous, the ranking for the users' experience may be a “Funny Scale.” The site will provide a type of ranking mechanism, where the experienced users 26, as shown in FIG. 1, or the “celebrity” may be chosen, either among all experiences posted or separated by category. For example, a user who has more posts about experiences relating to topic 6 than any other user for a fixed period of time (a week, a month, etc.), and/or receives the highest number of page views total from other users ranking their uploaded content, may receive an award from other users as the celebrity/most experienced user 26. Likewise, a user who has received higher rankings on “Funny Scales” than other users over a period of time, as measured by page views, may receive an award as the funniest User/Celebrity. The network can provide an incentive for users to win such an award.

Also, in accordance with a preferred embodiment of the present invention, another component of the system may comprise a tagging component connecting users by allowing each user to notify friends of a favorite piece of uploaded media on the network whether found on, including but not limited to, a user's public profile page 90, user-submitted topics, topics 6, topics page, and other network locations. In a preferred embodiment, for example, User 1, after viewing a humorous video, can notify their friends that this certain video upload is funny, and provide enough information so that User 1's friends can find the video, including information such as providing the direct link to the video itself, or a link to the personal profile site 60 of the user who actually uploaded the video and thus be able to access other related materials on that site. Also, the redirecting link may include an access window that lists links to other related sites that a user might be interested in.

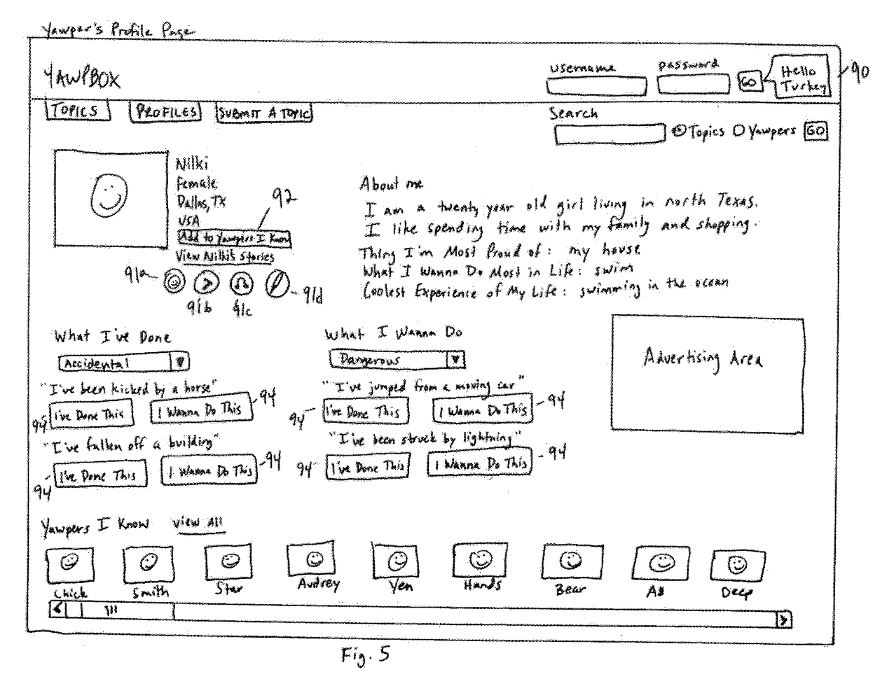

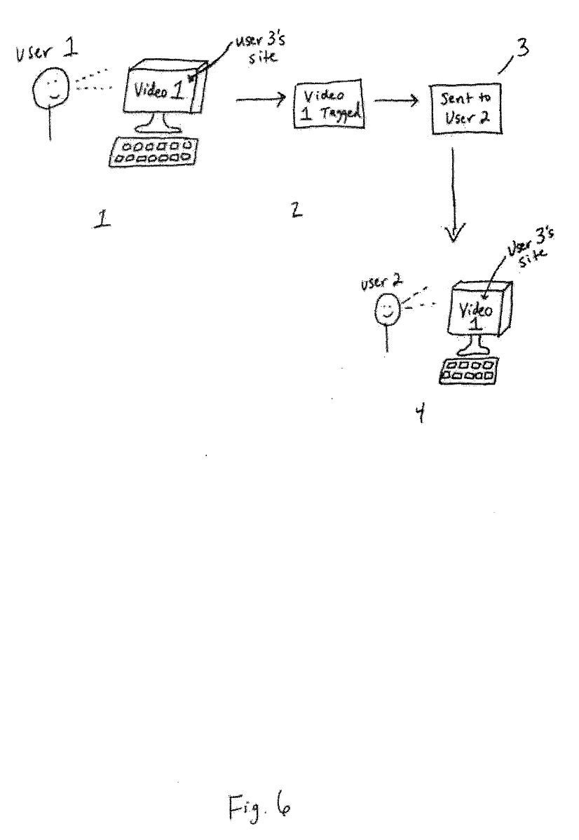

For example, in reference to FIG. 6, in step 1 User 1 views Video 1 on User 3's public profile site. In step 2, User 1 tags Video 1 and sends it to User 2 via email (or via text messaging, instant messaging, short messaging service, or other form of notice) and when User 2 receives the notification and clicks on the provided link to view Video 1, User 2 is redirected to User 3's personal profile site with the uploaded Video 1. Another window may appear that suggests and lists alternative sites also related to the material in Video 1, which may be any form of uploaded media on the network. So after viewing Video 1, User 2 may be interested in viewing more related material and can follow the alternative links provided by the network and proceed to other personal profile sites of users. After viewing these sites, User 2 may leave a note to User 3 about Video 1 on a message board on User 3's personal profile, as discussed earlier.

Another advantageous feature of the system includes a blogging section, allowing users and the website operator alike to discuss the issues of the site itself, topics, and other areas of interests. This provides the site an open forum for discussion and updates, including changes in the sites, notices issued from the website operator, other areas of note that users wish to discuss further and in a more public forum than amongst the limited numbers through personal profile contact. Blogging components of Web sites and other network sites are well known in the art and, hence need not be described in greater detail herein.

In an illustrative embodiment, the present invention could be embodied, for example, as a World Wide Web site employing, for instance, Windows Server software, available from Microsoft, Redmond, Wash. The various media content and user information could be stored, for instance, using well known database systems, such as a SQL-type database. The various pages and graphical user interfaces could be coded using any one or more of various well known programming languages, such as ASP, Net C#, and the like. The various software components could run on a standard hardware platform, such as, for instance one or more Power Edge servers, available from Dell Computers, Round Rock, Tex., preferably configured with a RAID array for storage, and preferably configured with a load balancer (e.g., a Coyote load balancer as available from CoyotePoint Systems, Inc., San Jose, Calif.), a firewall (e.g., a SonicWall Firewall available from SonicWall, Inc., Sunnyvale, Calif.), and a router (e.g., a Cisco router, Huawei router, and the like). These specifics are provided for example only and one skilled in the art will recognize a host of modifications, variations, substitutions, and alternatives to the exemplary components.

Although the present invention and its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of creating a community of users on a network comprising:
presenting a topic on a first user-accessible network site;
receiving from a user an indication that the user has experienced the topic;
receiving from the user content relating to the topic; and
posting on a second user accessible network site the content.

2. The method of claim 1 wherein the first user-accessible network site is a World Wide Web page.

3. The method of claim 2 wherein the first user-accessible network site and the second user-accessible network site are the same user-accessible network site.

4. The method of claim 1 wherein the content is selected from the group consisting of an audio file, a video file, a text file, an image, and combinations thereof.

5. The method of claim 1 further comprising:
receiving from a second user an indication that the second user desires to experience the topic.

6. The method of claim 5 further comprising:
providing a forum wherein the second user can contact the first user.

7. The method of claim 1 further comprising:
identifying a user and a second user having a common experience by analyzing comments posted by a first user and posted by a second user to a user-accessible network site.

8. The method of claim 7 wherein said analyzing comprises determining a number of words common to the comments posted by the first user and posted by the second user.

9. The method of claim 1 further comprising:
presenting on the first user-accessible network site reference to a public medium presentation relating to the topic.

10. The method of claim 9 wherein the public medium presentation is selected from the group consisting of a television show, a radio show, a podcast, and a simulcast.

11. The method of claim 9 wherein the reference is selected from the group consisting of promotional materials, scheduling information, a coupon, and a hyper-link.

12. A computer system comprising:
a computer server providing graphical user interface pages responsive to requests from a user;
a first graphical user interface page provided by the computer server and having a topic and having
user-posted content relating to the topic,
a user-input element wherein a user can indicate having experienced the topic and wherein a user can indicate a desire to experience the topic;
a second graphical user interface page provided by the computer server and relating to a specific user and having
content related to the topic posted by the specific user, and
a list of other users who have also posted content related to the topic.

13. The computer system of claim 12 further comprising:
a third graphical user interface page provided by the computer server and having
personal information relating to the specific user,
a list of topics experienced by the specific user, and
a list of topics desired to be experienced by the specific user.

14. The computer system of claim 12 wherein the first and second graphical user interface pages are World Wide Web pages.

15. The computer system of claim 12 wherein the first and second graphical user interface pages are coded using active server page (ASP) or C#.

16. The computer system of claim 12 wherein the user-posted content is selected from the group consisting of an audio file, a video file, a text file, an image, and combinations thereof.

17. A computer readable medium containing programming instructions to:
present on a remote computer a first graphical user interface page having
a link to user-posted content,
a link to a topic,
a first input element for a user to indicate having experienced the topic,
and a second input element for a user to indicate a desire to experience the topic.

18. The computer readable medium of claim 17 further including instructions to:
present on the remote computer a second graphical user interface page having information relating to a specific user including personal information, experience relevant to a topic, desire to experience a topic, an avatar representing the specific user, the identity of another user with whom the specific user shares a common experience or desire.

19. The computer readable medium of claim 17 further including instructions to:
present on the remote computer information relating to a forum wherein the topic is presented in another medium, wherein the another medium is television, radio, podcast, simulcast, text messaging, and combinations thereof.

20. The computer readable medium of claim 17 further including instructions to:
present on the remote computer of a first user an inquiry from a second user seeking to establish a relationship with the first user; and
present on the remote computer of the second user a response to the inquiry from the first user.
